(19) United States
(12) Patent Application Publication
(10) Pub. No.: US 2008/0278830 A1
(43) Pub. Date: Nov. 13, 2008

(54) Clip bracket for binocular and finder

(76) Inventor: William C. Burgess, Knoxville, TN (US)

Correspondence Address: KNOX PATENTS, P.O. BOX 30034, KNOXVILLE, TN, 37930-0034, US

(21) Appl. No.: 12/114,804

(22) Filed: May 4, 2008

Related U.S. Application Data
(60) Provisional application No. 60/916,653, filed on May 8, 2007.

(51) Int. Cl. G02B 7/02

(52) U.S. Cl. 359/818

(57) ABSTRACT

A bracket for releasably attaching a finder to a binocular with a single, tool-free operation. The bracket is configured to releasably receive a finder. The bracket also is configured to clamp onto a center rail of binoculars. The bracket includes a first member that is selectively biased toward a second member. The distal ends of the first and second members are configured to engage the binoculars such that the ends of the first and second members clamp onto the binoculars. In one embodiment, the first and second members are biased apart by a spring and a third member engages the first and second members to bring the first and second members together to clamp the binoculars' rail. In one embodiment, the two members are spring biased to clamp onto the binoculars' rail.

### CROSS-REFERENCE TO RELATED APPLICATIONS

This application claims the benefit of U.S. Provisional Application No. 60/916,653, filed May 8, 2007.

### STATEMENT REGARDING FEDERALLY SPONSORED RESEARCH OR DEVELOPMENT

Not Applicable

### BACKGROUND OF THE INVENTION

1. Field of Invention

This invention pertains to an accessory for attaching an optical finder to a binocular or other optical device.

2. Description of the Related Art

Binoculars are optical devices in common use to observe objects at a distance. They range from small handheld binoculars to large tripod mounted binoculars. The larger binoculars often have the forward ends of the objective barrels connected with a hinge and a bar or rail extending from the prism housing to the hinge. The rail provides structural strength to the binoculars. The rail also supports an adjustable or sliding connector for mounting the binoculars to a tripod or other support. Smaller binoculars often have a threaded mounting socket coaxial with the hinge in the prism housing. A bracket has a threaded member that engages the socket. The bracket is then attached to a tripod or other support.

Often, the larger binoculars are difficult to aim at a specific target. In those cases, a finder is often used. A finder is an optical device that is used to aim another device. Typically, finders have a low magnification, particularly when compared to an optical device the finder is used with. The finder may have a unitary power, such as a red dot finder. Other finders are small, low power telescopes.

A finder has an optical axis. When the finder's optical axis is parallel to the optical axis of the binoculars, any target obtained by the finder will be found with the binoculars. Accordingly, it is important that the alignment of the optical axis of the finder be maintained as parallel as possible with that of the binoculars.

Binoculars are typically portable optical devices. That is, binoculars are easily set up and used, unlike large telescopes that are permanently mounted in observatories. Because of their portability, binoculars are often carried in cases or pouches. If a finder is permanently attached or mounted to binoculars, the carrying case must be made larger to accommodate the finder. The size difference can be substantial because finders are often set away from the body of binoculars to aid in their use. In order to avoid increasing the size of the carrying case, it is desirable to remove the finder from the binoculars.

The use of finders is not limited to binoculars. Finders are also useful with telescopes, including portable telescopes such as spotting telescopes and small telescopes that are set up only when they are used. Such telescopes also benefit from using finders, even those that are removed from the telescope when the telescope is stored.

### BRIEF SUMMARY OF THE INVENTION

In accordance with the invention, a bracket receives a finder and secures the finder in a fixed position, and the bracket clamps to a central rail of the binoculars with the rail substantially aligned with the optical axis of the binoculars, such that the bracket maintains the parallel alignment of the finder's optical axis with the binoculars' optical axis. In this way the bracket attaches an optical finder, which requires a flat surface for mounting, to binoculars not having a suitable surface for releasably attaching the finder that conveniently allows the finder to be quickly attached to the surface of the binoculars with the optical axis of the finder substantially parallel with the optical axis of the binoculars each time the finder is attached to the binoculars.

In one such embodiment, a bracket configured to support a finder in a fixed position includes two members biased towards each other such that the two members clamp onto a member of the binoculars with a single, tool-free operation such that the optical axis of the finder is substantially parallel with the optical axis of the binoculars. In this way the bracket attaches a finder to the binoculars such that an optical axis of the finder is substantially aligned with an optical axis of the optical device each time the finder is attached to the optical device.

For example, the clip includes a clamp for attaching to a center bar, or rail, of a pair of binoculars. Some types of binoculars, particularly the larger binoculars, include a center bar that provides support and maintains alignment of the objective end of the binoculars with respect to the eyepiece end. The finder clip is configured for supporting an optical finder, such as a red-dot finder, to use in aiming the binoculars at a target.

The clip includes a first member with a vertical portion and a horizontal portion. The clip also includes a second member that, in combination with the vertical portion of the first member, forms a clamp that secures the clip to the binoculars. The horizontal portion of the first member receives a dovetail bracket or other device that allows a finder to be attached to the clip.

In one embodiment, the clamping end of the second member is biased away from the first member by a spring. A threaded member draws the clamping end of the first and second members together, thereby clamping the center rail between the first and second members. In one such embodiment, the second member includes a horizontal portion that engages the vertical portion of the first member and causes the second member to pivot about the contact point. In another such embodiment, the second member includes tabs that engage corresponding openings in the horizontal portion of the first member and the second member pivots about the connection of the tabs with the openings.

In another embodiment, the second member is pivotably attached to the first member. A spring biases the clamping end of the second member toward a corresponding clamping end of the first member, thereby forming a spring-biased clamp for attaching the clip to the rail. In one such embodiment, the second member is pivotably attached near its center and a spring engages the end of the second member opposite the clamping end. Adjacent the spring on the second member is a fingerhold for a user to compress the spring, which causes the clamping end of the clip to separate. In another such embodiment, the second member includes an opening around the pivoting axis that allows a spring with two tabs to be secured at the pivot.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a perspective exploded view of a binocular and finder with one embodiment of a clip;

FIG. 2 is a front view of one embodiment of a clip secured to the binocular rail;

FIG. 3 is a partial front view of a second embodiment of the clip;

FIG. 4 is a partial side view of the second member of the second embodiment of the clip;

FIG. 5 is a front view of another embodiment of a clip;

FIG. 6 is a perspective view of another embodiment of a spring; and

FIG. 7 is a side view of another embodiment of a second member for use with the spring shown in FIG. 6.

### DETAILED DESCRIPTION OF THE INVENTION

An apparatus for releasably attaching a finder to a binocular is disclosed. Binoculars are popular with persons wishing to visually observer birds and astronomical objects. Many binoculars are handheld, but other binoculars, particularly the larger ones, are used with a tripod or other mount. Also, the construction of binoculars varies. The binoculars that can not be handheld typically are constructed differently than those that can be handheld.

In the following description, directional references are used with respect to the orientation of the various embodiments illustrated in the figures, for example, the vertical portion 202-V and the upper end 506. These directional references apply only in reference to the figures. One skilled in the art will recognize that the orientation of the elements of a device will vary depending upon how the device is viewed.

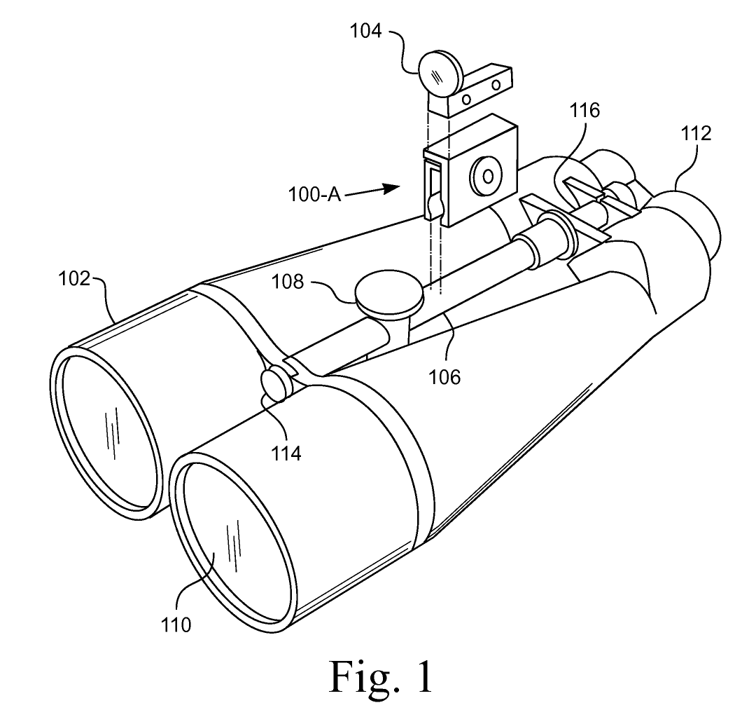

FIG. 1 illustrates a perspective exploded view of a binocular 102 and finder 104 with one embodiment of a clip 100-A. The illustrated binoculars 102 are the type that have two optical tubes that are connected near the objective lenses 110 and near the eyepieces 112. The front hinge 114 and the eyepiece hinge 116 are connected with a bar, or rail, 106. The rail 106 provides structural support for the binoculars 102 and ensures alignment, or collimation, of the two optical tubes of the binoculars 102. The rail 106 also provides an attachment to a mount, such as a tripod or pier. The attachment to the mount is by an attachment member 108 that slides along the rail 106 to a balance point, at which point the attachment member 108 is secured to the rail 108. The attachment member 108 includes a threaded opening on its bottom for receiving a stud or other complementary threaded member that protrudes from the mount.

The clip 100 is illustrated above the rail 106 and below the finder 104. The illustrated finder 104 is a red-dot finder commonly used as a targeting, or aiming, device. Those skilled in the art will recognize that other types of finders 104 can be attached to the clip 100 without departing from the spirit and scope of the present invention. The clip 100 clamps to the rail 106 of the binoculars 102 and supports the finder 104 in a fixed position. The clip 100 is readily removable from and reinstalled on the rail 106, thereby allowing the finder 104 to be stored separate from the binoculars 102 and easily installed on the binoculars 104 for use. Further, the clip 104 allows the alignment of the finder 104 to be set initially and returned to the same aligned position when the clip 100 is reattached to the rail 106.

Another type of binocular is one that does not include the center rail 106, but, instead, it has a threaded mounting hole coaxial with the prism housing hinge. The threaded hole receives a fastener to secure the binoculars to a mounting bracket, such as for supporting the binoculars on a tripod. In one embodiment, a short rail is secured in the threaded hole. The clip 100 attaches to the short rail. In one such embodiment, the short rail has a threaded portion protruding for screwing into the binoculars and the opposite end has a threaded hole for attaching to the mounting bracket for supporting the binoculars.

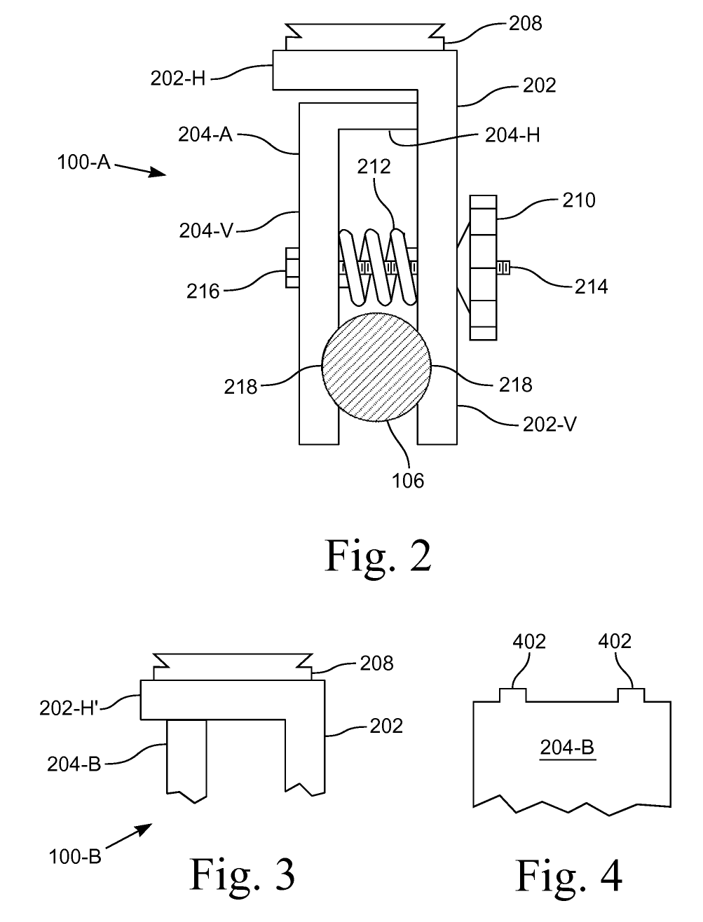

FIG. 2 illustrates a front view of one embodiment of a clip 100-A secured to the binocular rail 106. The clip 100-A includes a first member 202 and a second member 204-A. In general, the second member is referred herein by reference number 204 and the specific embodiments are indicated by a letter following the reference number. The first member 202 includes a vertical portion 202-V and a horizontal portion 202-H. Attached to the horizontal portion 202-H is a dovetail bracket 208, such as used to secure a finder 104. Those skilled in the art will recognize that other types of brackets than the dovetail bracket 208 can be used without departing from the spirit and scope of the present invention. The second member 204-A includes a vertical portion 204-A-V and a horizontal portion 204-A-H. The distal end of the horizontal portion 204-A-H of the second member 204-A contacts the vertical portion 202-V of the first member 202.

Adjacent the rail 106 are a pair of arcuate recesses 218 in the first and second members 202, 204-A. The recesses 218 have a radius equal to or less than the radius of the rail 106. The recesses 218 capture the rail 106 and prevent displacement of the rail 106 along the inside surface of the first and second members 202, 204-A. Between the inside surfaces of the first and second members 202, 204-A is a spring 212. A threaded member 214 connects the first and second members 202, 204-A. Adjacent the outside surface of the second member 204-A is the head 216 of the threaded member 214, which in the illustrated embodiment is a bolt. The end of the threaded member 214 opposite the head 216 has a threaded knob 210. Rotation of the knob 210 causes the first and second members 202, 204-A to be displaced relative to each other. The spring 212 has substantially flat ends and the first and second members 202, 204-A remain parallel to each other when they are moved by rotation of the knob 210 unless the distal end of the horizontal portion 204-A-H of the second member 204-A contacts the vertical portion 202-V of the first member 202.

When rotation of the knob 210 causes the first and second members 202, 204-A to draw together such that the horizontal portion 204-A-H of the second member 204-A contacts the vertical portion 202-V of the first member 202, the second member 204-A begins to pivot about the contact point between the horizontal portion 204-A-H of the second member 204-A and the vertical portion 202-V of the first member 202. The pivoting action causes the rail 106 to be pinched, or clamped, between the distal ends of the vertical portions 202-V, 204-A-V of the first and second members 202, 204-A.

In other embodiments, a latching mechanism replaces the threaded member 214 and knob 210. In one embodiment, the latching member includes a lever arm that engages a shaft between the first and second members 202, 204-A. Operation of the lever arm causes the first and second members 202, 204-A to move together, thereby locking the rail 106 between the first and second members 202, 204-A. Those skilled in the art will recognize that other mechanisms that cause the first and second members 202, 204 to move together for clamping the clip 100-A to the rail 106 can be used without departing from the spirit and scope of the present invention.

The bracket 208 is positioned at a distance from the rail 106 sufficient for the finder 104 to have a clear sight relative to the binoculars 102. That is, with the clip 100 attached to the binoculars 102, no part of the binocular 102 obstructs the view through the finder 104.

FIG. 3 illustrates a partial front view of a second embodiment of the clip 100-B. FIG. 4 illustrates a partial side view of the second member 204-B of the second embodiment of the clip 100-B. In the illustrated embodiment, the second member 204-B engages the horizontal portion 202-H of the first member 202 with a pivoting connection. The second member 204-B of the clip 100-B includes a vertical portion with a pair of tabs 402 protruding from the end of the second member 204-B that engage corresponding openings in the horizontal portion 202-H of the first member 202. The tabs 402 engaging the horizontal portion 202-H cause the second member 204-B to pivot where the tabs 402 engage the corresponding openings. The threaded member 214 and spring 212 keep the second member 204-B within a vertical position such that the tabs 402 continue to engage the openings in the horizontal portion 202-H when the knob 210 is operated.

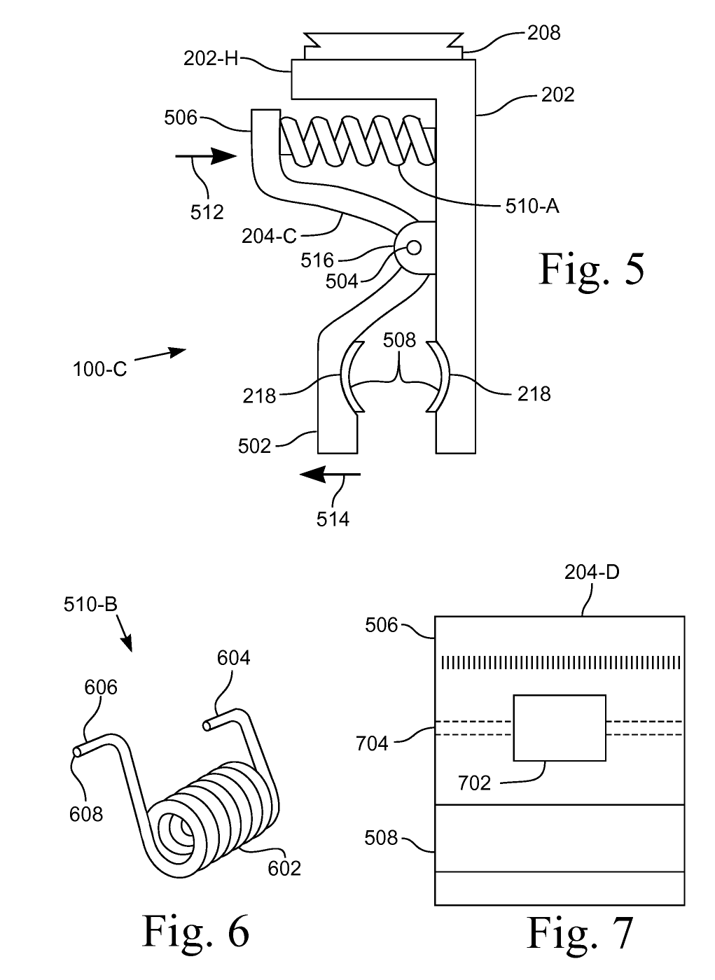

FIG. 5 illustrates a front view of another embodiment of a clip 100-C. In the illustrated embodiment, the second member 204-C is pivotably attached to tabs 516 protruding from the inside surface of the first member 202. A spring 510-A biases the upper end 506 of the second member 204-C to cause the clip 100-C to clamp the rail 106. When the upper end 506 is moved in a direction 512 toward the first member 202, the opposite end of the second member 204-C moves in an opposite direction 514 away from the first member 202.

In operation, a user squeezes the clip 100-C by pressing against the upper end 506 and the outside surface of the first member 202. The pressure of squeezing moves the upper end 506 in the direction 512 toward the first member 202, which moves the lower end 502 away from the first member 202, thereby increasing the gap between the lower end 502 and the first member 202. When the gap is increased sufficiently, the clip 100-C is movable relative to the rail 106 for engaging and disengaging the rail 106. The position of the pivot axel 504 (and the pivot) relative to the upper end 506 and the lower end 502 determines the force required by the operating user to open the gap and the force applied on the rail 106 when the clip 100-C is clamping the rail 106.

Also illustrated is a lining 508 adjacent the recesses 218 in the first and second members 202, 204-C. In one embodiment, the lining 508 is a material with a high coefficient of friction relative to the surface of the rail 506, such as a Vinyl or rubber-type material. When the clip 100 is clamped to the rail 106, the lining 508 prevents the clip 100 from rotating unintentionally about the rail 106. In one embodiment, the lining 508 is a resilient material that deforms when the clip 100 is clamped to the rail 106. Deformation of the lining 508 allows the clip 100 to accommodate rails 106 of different sizes, shapes, and configurations.

FIG. 6 illustrates a perspective view of another embodiment of a spring 510-B. FIG. 7 illustrates a side view of another embodiment of a second member 204-D for use with the spring 510-B shown in FIG. 6. In this embodiment of the clip 100-C, the spring 510-B is positioned in the opening 702 in the second member 204-D. A pivot axel 504 passes through the center of the spring 510-B, thereby retaining the spring 510-B in the clip 100-C. The first end 604 of the spring 510-B presses against the inside surface of the first member 202. The second end 606 of the spring 510-B presses against the second member 204-D near the upper end 506. The second end 606 has a tip 608 that protrudes away from the spring 510-B such that the tip 608 engages the second member 204-D near the opening 702.

The two ends 604, 606 have a natural position that causes the clip 100-C to assume a first position with the distance or gap between the lower end 502 and the first member 202 being less than the diameter of rail 106 such that the rail 106 is held captive by the clip 100-C. The two ends 604, 606 bias the upper portion of the second member 204-D away from the corresponding end of the first member 202, thereby biasing the lower ends of the first and second members 202, 204-D towards each other for securing the clip 100-C to the rail 106. In one embodiment, each of the two ends 604, 606 engage a socket that holds the corresponding end 604, 606 captive to the corresponding member 202, 204-D.

The clip 100 includes various functions. The function of clamping the rail 106 is implemented by the end 502 of the clip 100 opposite the end 202-H that supports the finder 104 being biased together.

The function of preventing rotation of the clip 100 about the longitudinal axis of the rail 106 is implemented, in one embodiment, by the lining 508 positioned adjacent the contact surface of the rail 106. In another embodiment, the recesses 218 in the first and second members 202, 204 have a serrated or non-smooth surface that has a high coefficient of friction for the rail 106.

The function of supporting the finder 104 is implemented, in one embodiment, by the dovetail bracket 208 positioned at the end of the clip 100 opposite the rail end.

The function of biasing the lower end 502 of the second member 204 towards the first member 202 is implemented, in various embodiments, by a spring 212, 510 with or without a compressing member. In one such embodiment, the spring 212 is between the pivot and the rail 106 and a threaded member 214, engaged by a knob 210, is a compressing member that forces the lower end 502 of the second member 204-A toward the first member 202. In another such embodiment, the spring 510-A is opposite the rail 106 with the pivot axis 504 between the spring 510 and the rail 106, whereby compression of the spring 510-A releases the rail 106. In still another such embodiment, the spring 510-B has operative ends 604, 606 opposite the rail 106 with the pivot axis 504 between the ends 604, 606 and the rail 106, whereby compression of the spring ends 604, 606 releases the rail 106.

The function of operating the clip 100-A, 100-B is implemented, in one embodiment, by the knob 210 that engages the threaded member 214 to move the first and second members 202, 204-A, 204-B together. In another embodiment, the knob 210 and threaded member 214 are replaced with a toggle that moves the clip 100-A, 100-B between a first and second position. The first position being one that clamps the rail 106 and the second position being one that releases the rail 106. In another embodiment, the function of operating the clip 100-C, 100-D is implemented by the upper end 506 of the second member 204-C, 204-D being manipulated toward the vertical portion 202-V of the first member 202. Moving the upper end 506 toward the corresponding end of the first member 202 causes the lower end 502 to move away from the corresponding end of the first member 202.

From the foregoing description, it will be recognized by those skilled in the art that a clip 100 for securing a finder 104 to a center rail 106 of a binocular 102 has been provided. The clip 100 includes a first and second member 202, 204 that is biased so as to grip, or clamp, the rail 106.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. An apparatus for attaching a finder to a binocular, said apparatus comprising:
a first member configured to receive the finder and to releasably support the finder in a fixed position; and
a second member configured to be biased relative to said first member, said first and second members each having a clamping end configured to clamp onto a rail of the binoculars such that an optical axis of the finder would be substantially parallel with an optical axis of the binoculars.

2. The apparatus of claim 1 further including a pad on one of said clamping ends, said pad disposed on a side of said one of clamping ends facing the other one of said clamping ends, said pad having a surface that inhibits rotational movement of said apparatus relative to said rail.

3. The apparatus of claim 1 wherein said first member has a length sufficient to provide a clear sight through said finder with respect to said binocular.

4. The apparatus of claim 1 further including a spring disposed between said first and second members, said spring being adjacent a medial point of each of said first and second members, and a third member configured to draw the first and second members together, thereby clamping said rail of the binoculars between said first and second members.

5. The apparatus of claim 1 wherein an end of said second member pivots relative to said first member, said end being distal to said clamping end of said second member.

6. The apparatus of claim 1 wherein said first and second members are pivotably connected.

7. The apparatus of claim 1 further including a spring positioned between said first and second members and a pivot joining a medial point of each of said first and second members, said spring biasing one of said clamping ends toward the other one of said clamping ends.

8. The apparatus of claim 7 wherein a second member end opposite said clamping end of said second member is configured to be manually moved toward said first member to move said clamping ends away from each other.

9. The apparatus of claim 7 wherein said spring biases said one of said clamping ends toward said other of said clamping ends with sufficient force to secure said first and second members to said rail.

10. An apparatus for attaching a finder to an optical device, said apparatus comprising:
a first member configured to receive the finder and to releasably support the finder in a fixed position, said first member having a first clamping end;
a second member having a second clamping end, said second clamping end adjacent said first clamping end;
a spring disposed between said first and second members; and
a third member configured to draw the first and second members together against the bias from said spring, thereby clamping a portion of said optical device between said first and second members such that an optical axis of the finder would be substantially parallel with an optical axis of the optical device.

11. The apparatus of claim 10 wherein an end of said second member pivots relative to said first member, said end being distal to said second clamping end.

12. The apparatus of claim 10 wherein said first and second members are pivotably connected.

13. The apparatus of claim 10 wherein said spring is adjacent a medial point of each of said first and second members.

14. The apparatus of claim 10 further including a pad disposed on a side of one of said first member and said second member adjacent an opposite clamping end, said pad having a surface that inhibits rotational movement of said first member relative to said optical device.

15. The apparatus of claim 10 wherein said optical device is a binocular.

16. An apparatus for attaching a finder to an optical device, said apparatus comprising:
a first member configured to receive the finder and to releasably support the finder in a fixed position, said first member having a first clamping end;
a second member having a second clamping end and an operator end, said second clamping end adjacent said first clamping end, said first and second members joined at a pivot; and
a spring biasing said first clamping end toward said second clamping end such that when a portion of said optical device is clamped between said first and second members then an optical axis of the finder would be substantially parallel with an optical axis of the optical device.

17. The apparatus of claim 16 wherein said operator end is configured to be manually moved toward said first member to cause said first clamping end to move away from said second clamping end.

18. The apparatus of claim 16 wherein said spring has sufficient force to bias said first clamping end toward said second clamping end to secure said first and second members to said optical device.

19. The apparatus of claim 16 further including a pad disposed on a side of one of said first member and said second member adjacent an opposite clamping end, said pad having a surface that inhibits rotational movement of said first member relative to said optical device.

20. The apparatus of claim 16 wherein said first member has a length sufficient to provide a clear sight through said finder with respect to said optical device.
